(19) United States
(12) Patent Application Publication
(10) Pub. No.: US 2011/0074100 A1
(43) Pub. Date: Mar. 31, 2011

(54) METHOD AND APPARATUS FOR USE IN A DOCUMENT JOGGER SYSTEM FOR AUTOMATICALLY DETECTING AND RESPONDING TO CONDITIONS OCCURRING IN THE DOCUMENT JOGGER SYSTEM

(76) Inventors: William F. Battle, Ann Arbor, MI (US); Philip D. Klug, Brighton, MI (US)

(21) Appl. No.: 12/570,097

(22) Filed: Sep. 30, 2009

(51) Int. Cl. B65H 7/14; G05B 19/04

(52) U.S. Cl. 271/227; 271/265.01; 700/213

(57) ABSTRACT

A method and apparatus for use in document jogger system are provided. The apparatus includes a document detector that detects the presence and absence of documents in the pocket of the document jogger system and that automatically activates and deactivates the document jogger system when documents are present and absent, respectively. Detecting the presence and absence of documents in the pocket and automatically activating and deactivating, respectively, the document jogger system based on the detected conditions, allows an increase in overall “wall-clock” throughput and a reduction in operator intervention to be realized. The increased throughput and the reduced operator intervention improve the overall quality of document processing and allow overall document processing costs to be reduced. The apparatus may also include one or more visual indicators and associated electrical circuitry for providing a visual indication of the status of the document jogger system.

### TECHNICAL FIELD

The instant disclosure relates to document jogger systems.

### BACKGROUND

A document jogger system is a document-handling machine that is used to mechanically line up the edges of a stack of documents, such as paper or envelopes, in order to make document handling tasks easier to perform. A typical document jogger system includes a housing in which electrical, mechanical and electromechanical components are housed and a pocket configured to receive documents to be jogged. The documents to be jogged are placed in the pocket and power is provided to the jogger system to cause the pocket to vibrate at a high rate of speed. As the pocket vibrates, edges of the documents are aligned against edges formed in the pocket until the edges of the documents are aligned.

Although document jogger systems vary in design, a typical document jogger system comprises a housing that includes a magnet positioned near a metal plate, a set of springs mechanically coupled to the housing and to the metal plate, and electrical circuitry. To activate the document jogger system, alternating current (AC) power is provided to the electrical circuitry of the document jogger system. The corresponding AC electrical current causes the poles of the magnet to switch polarity at the frequency of the AC current. As the polarity of the magnet switches, the metal plate coupled to the set of springs oscillates back and forth at the same frequency. The oscillation of the metal plate exerts forces on the housing that are translated through the housing to the pocket to cause the pocket to vibrate. The vibration of the pocket causes the documents in the pocket to be jogged. This jogging of the documents ultimately results in the documents becoming aligned in the pocket. Another example of a known type of document jogger system is disclosed in U.S. Pat. No. 6,299,159. The document jogger system disclosed in this patent uses a direct current (DC) vibration system comprising an unbalanced weight disposed on the end of a rotating shaft to create the necessary vibrations.

With current document jogger system designs, a first operation is performed by human operator during which documents to be jogged are placed in the pocket of the document jogger system, and then a second operation is performed during which the operator activates the system to cause the pocket to vibrate in the aforementioned manner. Typically, the operator activates the system by depressing a start button or turning a timer dial. The document jogger system is typically deactivated either by the operator depressing a stop button, turning the timer dial to the off position, or depressing the start button a second time to toggle it. Some document jogger systems have analog or digital timer circuitry that sets a timer to a predetermined time period when the system is activated. In such systems, expiration of the predetermined timer causes the system to automatically deactivate itself to terminate the jogging operation.

### SUMMARY

One disadvantage of current document jogger systems of the type described above is that the second operation that is performed by an operator to activate the document jogger system reduces overall “wall-clock” throughput. One reason for the reduced throughput is that some amount of time is consumed between the instant in time when the first operation is performed to place the documents in the pocket and the instant in time when the second operation is performed to activate the document jogger system. In time-critical environments in which these operations are performed many times in any given work day, this amount of time is multiplied by the total number of jogger operations being performed. Consequently, the reduction in throughput can be very significant and costly.

Another disadvantage of current document jogger systems of the type described above is that there is generally no way for an operator to know when a jogging operation has successfully completed. In document jogger systems that are configured to automatically terminate the jogging operation at the expiration of the aforementioned predetermined time period, the operator typically determines whether a jogging operation has completed by listening to hear whether the document jogger has been deactivated. In such cases, the operator typically removes the documents from the pocket when he or she no longer hears the document jogger system performing the jogging operation. One of the problems of using this technique is that document processing environments are generally very noisy environments due to multiple jogging operations and other document processing tasks being performed at the same time. Therefore, it is often difficult for an operator to determine through listening whether a particular document jogger system has completed and jogging operation and has deactivated itself. As a result, an operator may accidentally remove documents from the pocket of a document jogger system before the jogging operation has successfully completed, which can result in the documents not being precisely aligned with one another. This type of human error can lead to documents having to be re-jogged and other document processing difficulties, which can also reduce overall throughput and increase costs.

Accordingly, a need exists for a document jogger system and method that provides increased document jogging throughput. A need also exists for a document jogger system that enables an operator to easily determine when a document jogger system is or is not currently performing a jogging operation.

The instant disclosure provides a method and an apparatus for use in a document jogger system for activating and deactivating the document jogger system based on determinations as to whether or not documents are currently located in a pocket of the document jogger system. The apparatus comprises a document detector, a controller and a jogger actuator circuit. The document detector is configured to detect whether or not documents are currently located in the pocket of the document jogger system and to output a document detection signal indicative of whether or not documents are currently located in the pocket. The controller is configured to receive the document detection signal output by the document detector and to perform a document detection algorithm that analyses the document detection signal and determines whether or not documents are currently present in or absent from the pocket. If the controller determines that documents are currently located in the pocket, the controller produces a jogger activation signal. The jogger actuator circuit is configured to cause a jogger actuator of the document jogger system to be activated if the jogger actuator circuit receives the jogger activation signal produced by the controller. Activation of the jogger actuator causes a jogging operation to be performed during which document currently located in the pocket are vibrated.

The method comprises the following. In a document detector of a document jogger system, detecting whether or not documents are currently located in the pocket of the document jogger system and outputting a document detection signal indicative of whether or not documents are currently located in the pocket. In a controller of the document jogger system, receiving the document detection signal output by the document detector and performing a document detection algorithm that analyses the document detection signal and determines whether or not documents are currently present in or absent from the pocket. If the controller determines that documents are currently located in the pocket, the controller produces a jogger activation signal. In a jogger actuator circuit of the document jogger system, a jogger actuator of the document jogger system is activated if the jogger actuator circuit receives the jogger activation signal produced by the controller. Activation of the jogger actuator causes a jogging operation to be performed during which document currently located in the pocket are vibrated.

The instant disclosure is also directed to a computer program for use in a document jogger system for activating and deactivating the document jogger system based on determinations as to whether or not documents are currently located in a pocket of the document jogger system. The program is stored on a computer-readable medium and includes at least first, second and third sets of instructions. The first set of instructions receives a document detection signal indicative of whether or not documents are currently located in a pocket of the document jogger system. The second set of instructions analyzes the document detection signal to determine whether or not documents are currently present in or absent from the pocket. The third set of instructions causes a jogger actuator of the document jogger system to be activated if the second set of instructions determines that documents are currently present in the pocket.

These and other features and advantages will become apparent from the following description, drawings and claims.

### BRIEF DESCRIPTION OF THE DRAWINGS

FIG. 1 illustrates a block diagram of the apparatus of the document jogger system in accordance with an illustrative embodiment.

FIG. 2 illustrates a flowchart that represents the method in accordance with an embodiment for performing document detection in a document jogger system.

FIG. 3 illustrates a front perspective view of an example of a document jogger system that incorporates the apparatus shown in FIG. 1.

FIG. 4 illustrates a block diagram of the apparatus shown in FIG. 1 having an IR-emitting LED and an IR-sensing photodiode that function as the optical transmitter and the optical receiver, respectively, of the document jogger system shown in FIG. 3.

FIG. 5 illustrates a flowchart that represents an illustrative embodiment for performing a visual status algorithm in a document jogger system that incorporates the apparatus shown in FIG. 1.

### DETAILED DESCRIPTION

In accordance with an embodiment, a document jogger system is provided that includes a document detection apparatus that detects the presence and absence of documents in the pocket of the document jogger system and that automatically activates and deactivates the document jogger system when documents are present and absent, respectively. Detecting the presence and absence of documents in the pocket and automatically activating and deactivating, respectively, the document jogger system based on the detected conditions, allows an increase in overall “wall-clock” throughput and a reduction in operator intervention to be realized. The increased throughput and the reduced operator intervention improve the overall quality of document processing and allow overall document processing costs to be reduced. In accordance with another embodiment, the document jogger system includes one or more visual indicators and associated electrical circuitry for providing a visual indication of the status of the document jogger system. The visual status indication is an indication of one or more of the following conditions: (1) the document jogger system is currently performing a jogging operation, (2) electrical power currently is currently being provided to the document jogger system, and (3) documents currently located in the pocket of the document jogger system have successfully been jogged and are ready to be removed from the pocket.

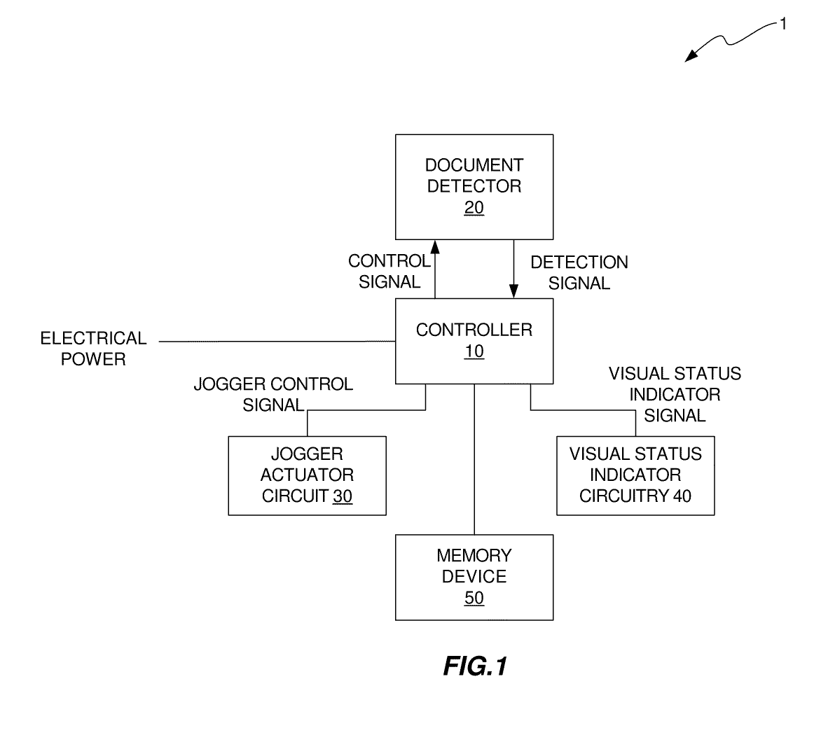

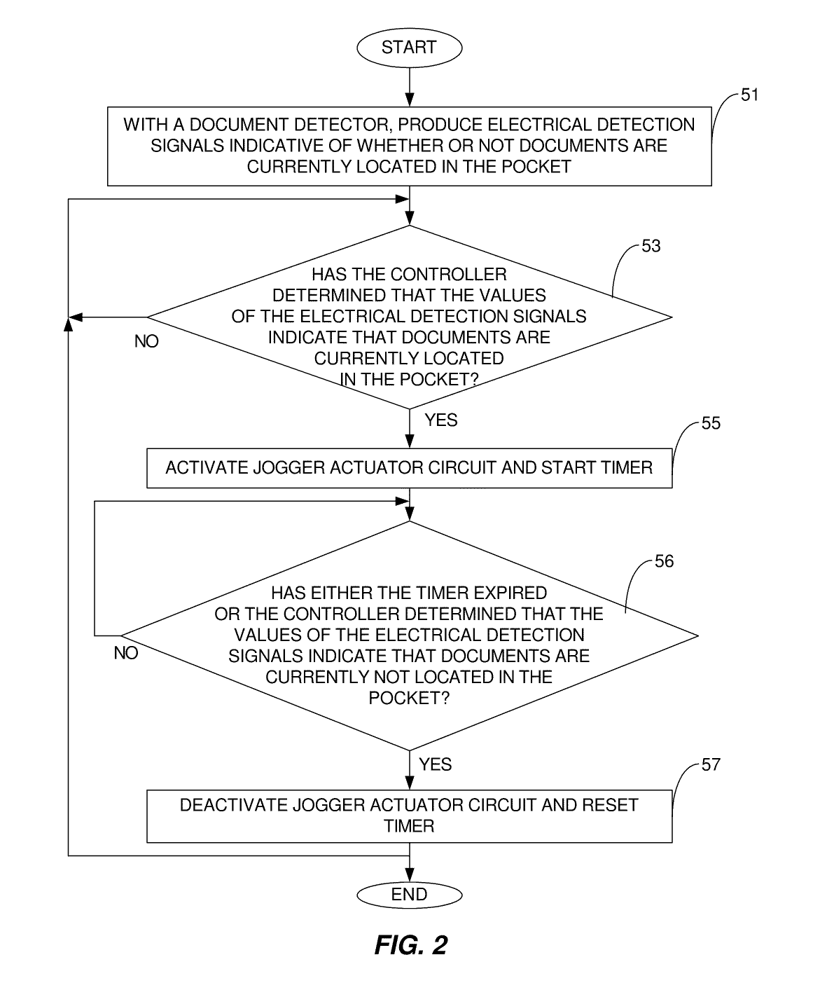

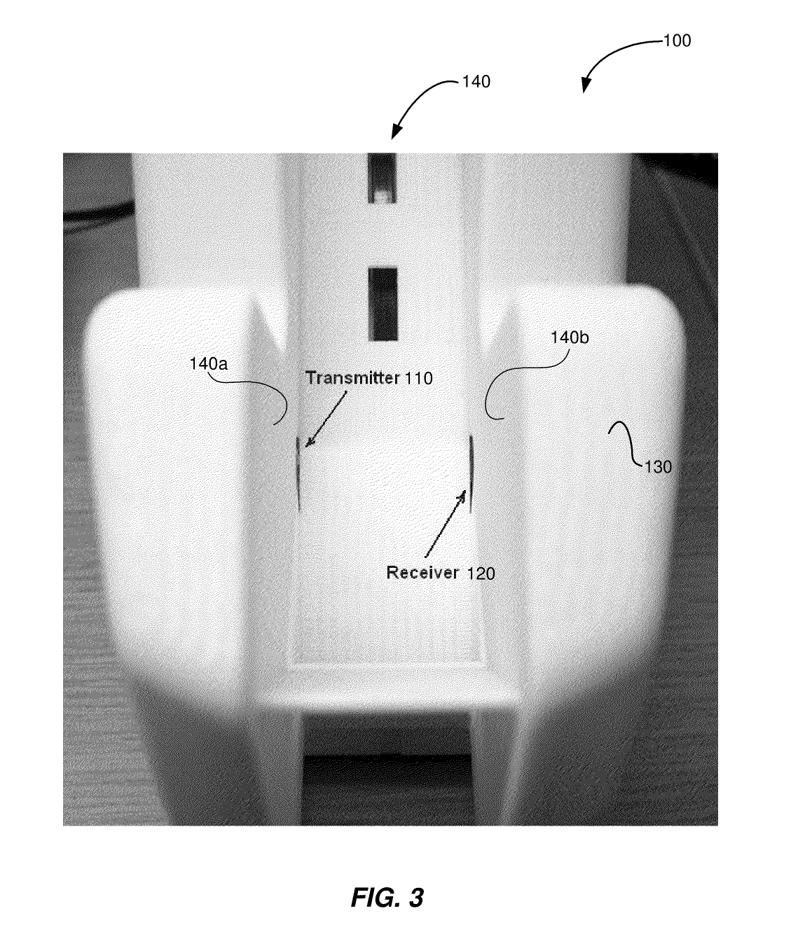

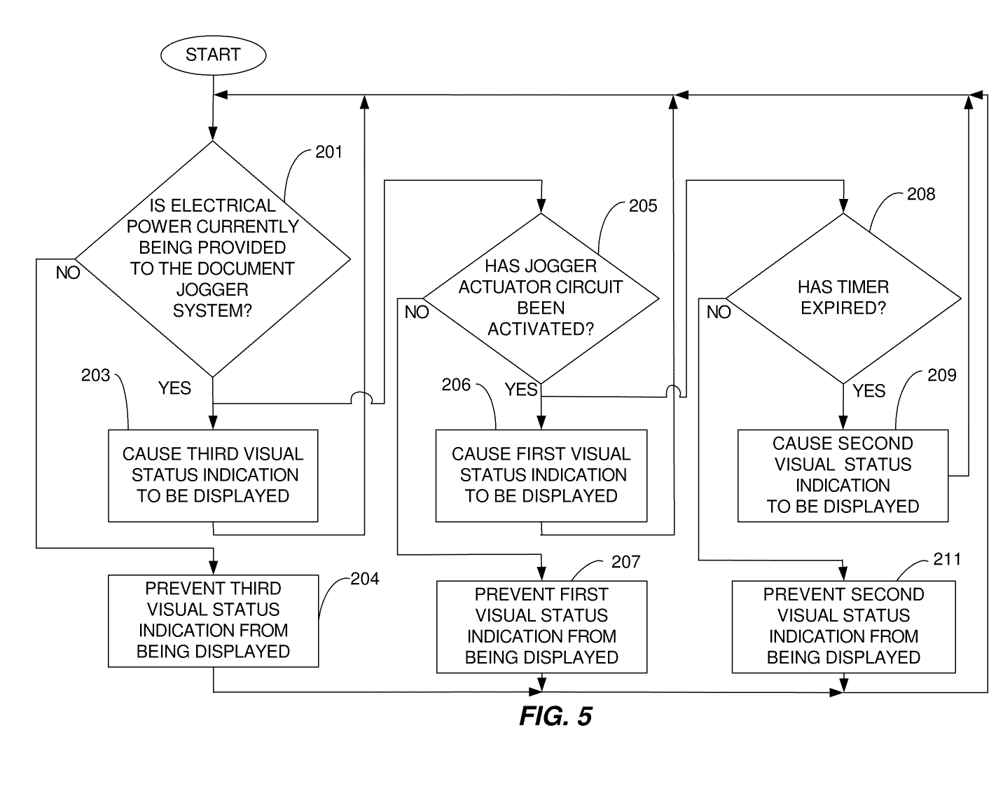

FIG. 1 illustrates a block diagram of the apparatus 1 of the document jogger system in accordance with an illustrative embodiment. An illustrative embodiment of a document jogger system that incorporates the apparatus 1 will be described below with reference to FIGS. 2 and 3. The apparatus 1 includes a controller 10 for controlling operations of the apparatus 1, a document detector 20 for detecting the presence and absence of documents, and a jogger actuator circuit 30 for creating vibrations that cause documents placed in the pocket of the document jogger system (FIGS. 2 and 3) to be jogged. In addition, as will be described in more detail below with reference to FIG. 5, the apparatus 1 may also include a visual status indicator 40 for indicating one or more of the aforementioned status conditions.

The apparatus 1 operates as follows. The controller 10 sends a control signal to the document detector 20 to activate the document detector 20. The nature of the control signal will depend on the type and configuration of the document detector 20. As will be described in more detail below with reference to FIGS. 2-4, the document detector 20 may be an optical detector, a proximity detector, a weight detector, a sound detector, or the like. The document detector 20 outputs a detection signal that is indicative of whether or not documents are currently located in the pocket of the document detector 20. The controller 10 receives the detection signal that is output by the document detector 20. The controller 10 is configured to perform a document detection algorithm that processes the detection signal and determines whether or not the value of the detection signal indicates that documents are currently located in the pocket. If the controller 10 determines that the value of the detection signal indicates that documents are currently located in the pocket, the controller 10 outputs a jogger actuation signal to the jogger actuator circuit 30. When the jogger actuator circuit 30 receives this signal, the jogger actuator circuit 30 causes the pocket to vibrate in the manner described above to perform the jogging operation.

When the controller 10 sends the jogger actuation signal to the jogger actuation circuit 30 to cause it to begin vibrating the pocket, the controller 10 sets a timer to a predetermined time period. The controller 10 continues to monitor the detection signal output from the document detector 20. If either of the following conditions occur, the controller 10 sends a jogger control signal to the jogger actuator circuit 30 that causes the jogger actuator circuit 30 to stop vibrating the pocket: (1) the predetermined time period expires, or (2) the value of the detection signal output from the document detector 20 indicates that documents currently are not located in the pocket. The predetermined time period is selected to correspond to an amount of time that is typically required in order for a successful jogging operation to be completed. Thus, if either the timer expires or the documents are removed from the pocket, the current jogging operation will be halted.

An advantage of such an embodiment is that it obviates the need for a human operator to initiate or terminate a jogging operation. When documents are not located in the pocket of the document jogger system, the jogger actuator circuit 30 is inactive such that the pocket of the document jogger system is not being vibrated. When documents are placed in the pocket, the jogger actuator circuit 30 begins vibrating the pocket and continues vibrating the pocket until either (1) the predetermined time period expires, or (2) the value of the detection signal output from the document detector 20 indicates that documents currently are not located in the pocket. Therefore, no act is required by an operator in order to initiate a jogging operation, other than placing documents to be jogged in the pocket. Similarly, no act is required by an operator in order to terminate a jogging operation, other than removing documents from the pocket or waiting for the predetermined time period to expire. This feature saves time and resources and increases overall document processing throughput, which, in turn, reduces overall document processing costs. Another advantage of this embodiment is that it saves electrical power in that the jogger actuator circuit 30 is inactive whenever either (1) no documents are located in the pocket, or (2) whenever the predetermined time period has expired after performing a jogging operation. This feature reduces costs in terms of the amount of electrical power that is consumed by the system. In addition, maintaining the jogger actuator circuit 30 in an inactive state under these conditions reduces operational and maintenance costs associated with the system.

FIG. 2 illustrates a flowchart that represents a method in accordance with an embodiment for performing document detection in a document jogger system. For illustrative purposes, the method will be described assuming the apparatus 1 shown in FIG. 1 is incorporated into the document jogger system. The document detector 20 of the document jogger system produces detection signals that are indicative of whether or not documents are currently located in the pocket of the document jogger system, as indicated by block 51. As the detection signals are produced, they are processed by the controller 10, which determines, based on the values of the detection signals, whether or not documents are currently located in a pocket of the document jogger system, as indicated by block 53. If a determination is made at block 53 that documents are not currently located in the pocket, then the process remains at block 53. If a determination is made at block 53 that documents are currently located in the pocket, then the process proceeds to block 55. At block 55, the controller activates the jogger actuator circuit 30 to cause the pocket to vibrate and sets a timer to a predetermined time period.

The process then proceeds to block 56, at which a determination is made as to whether either of the following conditions has occurred: (1) the timer has expired, or (2) the controller 10 has determined that the value of the detection signal indicates that documents are not currently located in the pocket. If the controller 10 determines that one or more of these conditions exists, then the process proceeds to block 57. At block 57, the controller 10 deactivates the jogger actuator circuit 30. The process then returns to block 53, at which the controller 10 continues to process the detection signals produced by the document detector 20 to determine when documents have been placed in the pocket.

FIG. 3 illustrates a front perspective view of an example of a document jogger system 100 that incorporates the apparatus 1 shown in FIG. 1. In accordance with this embodiment, the document detector 20 includes an optical transmitter 110 and an optical receiver 120. The optical transmitter 110 and the optical receiver 120 are located on first and second sides 140a and 140b, respectively, of a pocket 140 formed in a housing 130 of the document jogger system 100. The optical transmitter 110 may be, for example, an LED that produces optical signals having a particular wavelength, such as, for example, a wavelength in the infrared (IR) wavelength range. The optical receiver 120 may be, for example, a photodiode capable of sensing optical signals having the same wavelength as those produced by the optical transmitter 110. In the illustrated embodiment, the optical transmitter 110 is located on side 140a of the pocket 140 and the optical receiver 120 is located on side 140b of the pocket 140.

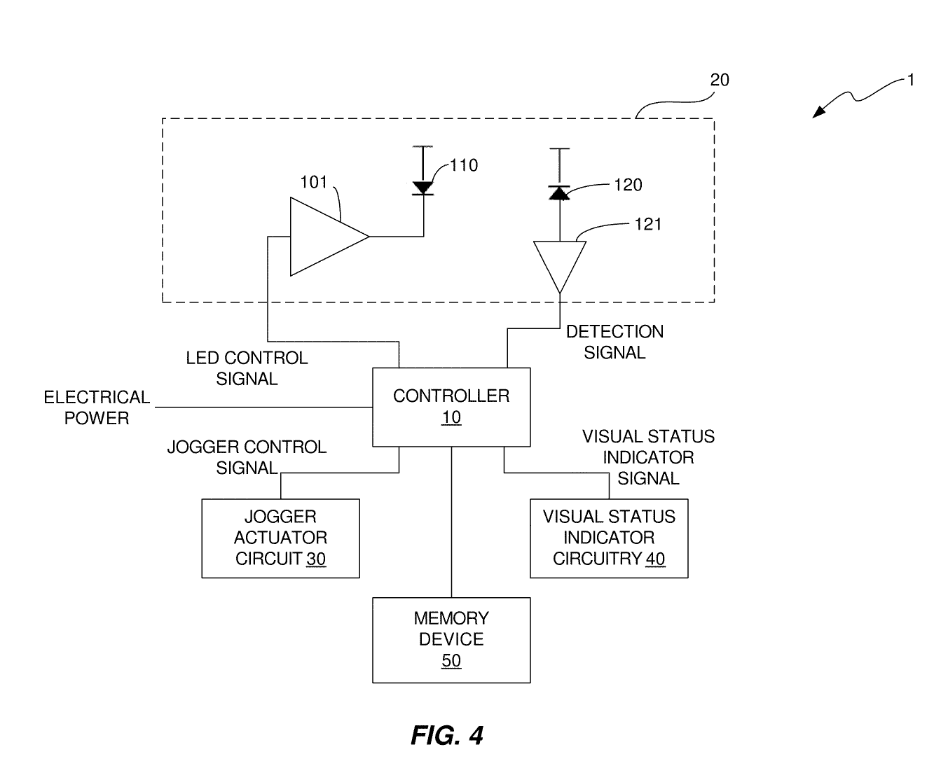

FIG. 4 illustrates an exemplary block diagram of the apparatus 1 shown in FIG. 1 having an IR-emitting LED 110 and an IR-sensing photodiode 120 that function as the optical transmitter 110 and the optical receiver 120, respectively, shown in FIG. 3. In this example, the control signal sent from the controller 10 (FIG. 1) to the document detector 20 is an LED drive signal that causes an LED driver 101 to drive the IR-emitting LED 110. The detection signal produced is an electrical signal output by the IR-sensing photodiode 120 in response to optical IR signals received by the IR-sensing photodiode 120 and amplified by an amplifier 121. It should be noted, however, that the instant disclosure is not limited with respect to the wavelengths of the optical signals or with respect to the types of optical transmitters and receivers that are used in the apparatus 10.

When documents are located in the pocket 140, the documents block IR optical signals produced by the IR-emitting LED 110 and thereby prevent them from being received by the IR-sensing photodiode 120. Consequently, when documents are present in the pocket 140, the electrical signals that are produced by the IR-sensing photodiode 120 will have values that the controller 10 will interpret as corresponding to the presence of documents in the pocket 140. When documents are not located in the pocket 140, the IR signals produced by the IR-emitting LED 110 are received by the IR-sensing photodiode 120. Consequently, when documents are not currently located in the pocket 140, the electrical signals that are produced by the IR-sensing photodiode 120 will have values that the controller 10 will interpret as corresponding to the absence of documents in the pocket 140.

It should be noted that wavelengths of light other than IR wavelengths may be used for this purpose. IR wavelengths are well suited for use with this embodiment due to the fact that IR wavelengths can easily be distinguished from visible and ambient wavelengths of light and due to the fact that IR transmitters and receivers are relatively inexpensive. It should also be noted that one or more optical or electrical filters (not shown) may be incorporated into the apparatus 10 in order to filter out wavelengths ambient and visible light so that only the effects of wavelengths of light that are produced by the LED 110 are measured by the controller 10. In addition, although the LED 110 and the photodiode 120 are shown in FIG. 3 as being located on opposite sides 140a and 140b of the pocket 140, the Led 110 and the photodiode 120 may be located on the same side (e.g., side 140a) of the pocket 140. In the latter case, when documents are located in the pocket 140, the optical signals produced by the LED 110 will be reflected onto the photodiode 120 and the electrical signals produced by the photodiode 120 will have values that the controller 10 will interpret as corresponding to the presence of documents in the pocket 140. When documents are not located in the pocket 140, the optical signals produced by the LED 110 will propagate in directions away from the LED 110 and the photodiode 120. Consequently, when documents are not currently located in the pocket 140, the electrical signals that are produced by the photodiode 120 will have values that the controller 10 will interpret as corresponding to the absence of documents in the pocket 140.

With reference again to FIG. 1, a variety of devices other than optical detection devices are suitable for use as the document detector 20, including, for example, and without limitation, proximity sensors, weight sensors, and sound sensors. The typical proximity sensors that may be used for this purpose includes a transducer that produces an electrical signal indicative of whether a document has come into contact with the transducer. Such a sensor may be placed at, for example, one or more locations on one or both of the sides 140a, 140b of the pocket 140 (FIG. 3). A typical weight sensor that may be used for this purpose includes a transducer that senses when the weight of pocket 140 is above or below a threshold weight value. In the case of a weight sensor, the pocket 140 may be movable in a manner similar to the manner in which a weight scale is movable so that, as documents are placed in the pocket, movement of the pocket 140 provides an indication that documents are present in the pocket 140.

A typical sound sensor that may be used for this purpose includes a sound wave transmitter and a sound wave receiver. The sound waves that are used for this purpose will typically be outside of the audible range of the human ear. The sound wave transmitter may be positioned at a location on side 140a, for example, and the sound wave receiver may be positioned at a location on side 140b, for example, across from the sound wave transmitter. In this case, when documents are located in the pocket 140, the documents block sound waves produced by the sound wave transmitter and thereby prevent them from being received by the sound wave receiver. Consequently, when documents are present in the pocket 140, the electrical signals that are produced by the sound wave transmitter will have values that the controller 10 will interpret as corresponding to the presence of documents in the pocket 140. When documents are not located in the pocket 140, the sound waves produced by the sound wave transmitter are received by the sound wave receiver. Consequently, when documents are not currently located in the pocket 140, the electrical signals that are produced by the sound wave transmitter will have values that the controller 10 will interpret as corresponding to the absence of documents in the pocket 140.

As indicated above, the apparatus 1 (FIGS. 1 and 4) may also include visual status indicator circuitry 30 for providing visual indications of one or more of a plurality of conditions, including the following: (1) the document jogger system is currently performing a jogging operation, (2) documents currently located in the pocket of the document jogger system have been successfully jogged and are ready to be removed from the pocket, and (3) electrical power is currently being provided to the document jogger system. The controller 10 is configured to execute a visual status algorithm that determines if one or more of these conditions exists, and if so, causes the visual status indication circuitry 30 to display a corresponding visual status indication. This algorithm may be part of the document detection algorithm described above or it may be a separate algorithm. Because some of the determinations are made by the controller 10 in performing the document detection algorithm described above with reference to FIG. 2, it can be computationally efficient for these algorithms to be combined into a single algorithm, although it is not necessary to do so. If the apparatus 10 does not include the visual status indicator circuitry 30, then it is not necessary for the controller 10 to perform the visual status algorithm. Similarly, if the apparatus 10 does not include the document detector 20, then it is not necessary for the controller 10 to perform the document detection algorithm. On the other hand, the apparatus 10 includes both the document detector 20 and the visual status indicator circuitry 30, then the two corresponding algorithms may be performed by the same components due to the fact that the algorithms share some common functionality.

An exemplary visual status algorithm is performed as follows. If the controller 10 activates the jogger actuator circuit 30 and sets the timer, as described above with reference to FIG. 2, the controller 10 provides a first visual indication signal value to the visual status indicator circuit 30 to cause it to display a first visual status indication. The first visual status indication indicates that condition (1) currently exists. If the controller 10 deactivates the jogger actuator circuit 30 due to the controller 10 determining that the aforementioned timer has expired, the controller 10 provides a second visual status indication signal value to the visual status indicator circuit 30 to cause it to display a second visual status indication. The second visual status indication indicates that condition (2) currently exists. If the controller 10 determines that electrical power is currently being provided to the apparatus 1, the controller 10 provides a third visual status indication signal value to the visual status indicator circuit 30 to cause it to display a third visual status indication. The third visual status indication indicates that condition (3) currently exists.

The visual status indicator circuit 30 typically includes a multi-colored LED capable of displaying at least three different visual indications for conditions (1), (2) and (3), or three separate LEDs of different colors for separately displaying three different visual indications for conditions (1), (2), and (3). The visual indicator circuitry 30 typically also includes electrical circuitry for driving the LED or LEDs based on the visual status indication signal values output from the controller 10 to the visual status indicator circuit 30. In some embodiments, the visual status indicator signal may comprise a multi-bit signal with at least one bit describing each one of the respective status conditions (1), (2) and (3). The disclosed document jogger system, however, is not limited with respect to the type or configuration of the visual status indicator circuit 30.

FIG. 5 illustrates a flowchart that represents an illustrative embodiment for performing the visual status algorithm in a document jogger system that incorporates an apparatus of the type shown in FIG. 1. For ease of illustration and in the interest of brevity, it will be assumed that the visual status algorithm is part of the document detection algorithm described above with reference to FIGS. 1 and 2. At block 201, the controller 10 determines whether or not electrical power is currently being provided to the apparatus 10. If not, the process proceeds to block 204 at which the controller 10 prevents the third visual status indication from being displayed by the visual status indicator circuitry 40. In some embodiments, if no power is being provided to the apparatus 10, then the controller 10 also is not receiving power, in which case no power is being provided to display the third visual status indication. Thus, in the latter case, the steps represented by blocks 201 and 204 can be eliminated.

From block 204, the process returns to block 201. If the controller 10 determines that electrical power is currently being provided to the apparatus 10, then the process proceeds to block 203, at which the controller 10 causes the visual status indicator circuitry 40 to display the third visual status indication. For example, at block 203, the controller 10 may assert the bit associated with the third visual status condition, whereas at block 204, the controller 10 may deassert the same bit. From blocks 203 and 204, the process returns to block 201 at which the controller 10 continues to monitor the output of block 55 in FIG. 2 to determine whether or not electrical power is currently being provided to the document jogger system.

If a determination is made at block 201 that electrical power is currently being provided to the document jogger system, then the process may proceed to block 205 contemporaneously as the process proceeding to block 203. Thus, in accordance with this illustrative embodiment, the process represented by blocks 205-207 is generally performed in parallel with the process represented by blocks 203-204. Block 205 monitors the process represented by block 55 in FIG. 2 and determines whether or not the jogger actuator circuit 30 has been activated. Because the controller 10 is responsible for activating and deactivating the jogger actuator circuit 30, as described above with reference to FIG. 2, the controller 10 makes the determination at block 205 by simply determining whether the jogger actuator circuit 30 is currently activated (i.e., whether the controller 10 has not yet deactivated the jogger actuator circuit 30 since activating it).

If the controller 10 determines at block 205 that the jogger actuator circuit 30 is currently activated, the process proceeds to block 206 at which the controller 10 causes the visual status indicator circuitry 40 to display the first visual status indication to visually indicate that a jogging operation is currently being performed. The process then returns to block 201. If the controller 10 determines at block 205 that the jogger actuator circuit 30 is not currently activated, then the process proceeds to block 207 at which the controller 10 prevents the visual status indicator circuitry 40 from displaying the first visual status indication. For example, at block 206, the controller 10 may assert the bit associated with the first visual status condition, whereas at block 207, the controller 10 may deassert the bit associated with the first visual status condition. From block 207, the process again returns to block 201.

If a determination is made at block 205 that a jogging operation is currently being performed, then the process proceeds to block 208 contemporaneously with the process proceeding to block 206. Thus, in accordance with this illustrative embodiment, the process represented by blocks 206-207 is generally performed in parallel with the process represented by blocks 208-211. At block 208, the controller 10 monitors the process represented by block 55 in FIG. 2 to determine whether or not the timer set at block 55 in FIG. 2 has expired. If so, the process proceeds to block 209 at which the controller 10 causes the visual status indicator circuitry 40 to display the second visual status indication to visually indicate that the jogging operation has successfully completed and that the documents located in the pocket 140 are ready to be removed. From block 209, the process returns to block 201. If, at block 208, the controller 10 determines that the timer set at block 55 in FIG. 2 has not yet expired, then the process proceeds to block 211 at which the controller 10 prevents the visual status indicator circuitry 40 from displaying the second visual status indication. For example, at block 209, the controller 10 may assert the bit associated with the second visual status condition, whereas at block 211, the controller 10 may deassert the bit associated with the second visual status condition. From block 211, the process returns to block 201.

It can be seen from the method described above with reference to FIG. 5 that the portion of the visual status algorithm represented by blocks 205-211 is only performed if a determination has been made by the controller at block 201 that electrical power is currently being provided to the document jogger system. In addition, the portion of the visual status algorithm represented by blocks 208-211 is only performed if a determination has been made at block 205 that a jogging operation is currently being performed. By configuring the algorithm in this manner, the controller 10 does not spend computational resources performing the portions of the algorithm represented by blocks 205-211 when electrical power is not being provided to the document jogger system. This feature reduces overall processing overhead and power consumption. However, as will be understood by persons of ordinary skill in the art, in view of the instant disclosure, many modifications may be made to the algorithm represented by the flowchart of FIG. 5 while still achieving the goals of providing the visual status indications. The flowchart shown in FIG. 5 is merely one example of the manner in which the controller 10 may perform the visual status algorithm.

The controller 10 may be a type of computational device, such as, for example, a microprocessor, a microcontroller, a programmable logic array (PLA), a programmable gate array (PGA), or a combination of two or more of such devices. Alternatively, the controller 10 may be made up of one or more discrete analog and/or digital components, such as, for example, a combination of digital logic gates arranged to perform the operations described above with reference to FIGS. 1-5. The algorithms represented by the flowcharts shown in FIGS. 2 and 5 may be performed in the controller 10 in hardware, software, firmware, or a combination thereof. Any computer instructions for performing these algorithms will be performed in some type of computer-readable medium, such as, for example, a random access memory (RAM) device, a read-only memory (ROM) device, a programmable ROM (PROM) device, an erasable PROM (EPROM) device, a compact flash memory device, or any other type of memory device. The memory device may be a device that is separate from the controller 10, such as memory device 50 shown in FIGS. 1 and 4, or it may be an integral part of the controller 10.

It should be noted that the disclosed apparatuses and methods have been described with reference to illustrative embodiments to demonstrate principles and concepts, and features that may be advantageous in some embodiments. The methods and apparatuses of the instant disclosure are not intended to be limited to these illustrative embodiments, as will be understood by persons of ordinary skill in the art in view of the description provided herein. A variety of modifications can be made to the embodiments described herein, and all such modifications are within the scope of the instant disclosure, as will be understood by persons of ordinary skill in the art.

What is claimed is:

1. An apparatus for use in a document jogger system for activating and deactivating the document jogger system based on determinations as to whether or not documents are currently located in a pocket of the document jogger system, the apparatus comprising:
a document detector configured to detect whether or not documents are currently located in the pocket of the document jogger system and to output a document detection signal indicative of whether or not documents are currently located in the pocket;
a controller configured to receive the document detection signal output by the document detector and to perform a document detection algorithm that analyses the document detection signal and determines whether or not documents are currently present in or absent from the pocket, wherein if the controller determines that documents are currently located in the pocket, the controller produces a jogger activation signal; and
a jogger actuator circuit configured to cause a jogger actuator of the document jogger system to be activated if the jogger actuator circuit receives the jogger activation signal produced by the controller, wherein activation of the jogger actuator causes a jogging operation to be performed during which document currently located in the pocket are vibrated.

2. The apparatus of claim 1, wherein the document detector comprises an optical transmitter and an optical receiver, the optical transmitter being configured to transmit optical signals of a particular wavelength or wavelength range, the optical receiver being configured to detect optical signals of the particular wavelength or wavelength range and to produce the document detection signal that is output from the document detector, wherein if documents are currently located in the pocket, the document detection signal produced by the optical receiver indicates that documents are currently present in the pocket, and wherein if documents are not currently located in the pocket, the document detection signal produced by the optical receiver indicates that documents are currently absent from the pocket.

3. The apparatus of claim 2, wherein the optical transmitter is an infrared (IR) light emitting diode (LED) and wherein the optical receiver is an IR photodiode.

4. The apparatus of claim 2, wherein the optical transmitter and the optical receiver are positioned on opposite sides of the pocket of the document jogger system such that if documents are currently present in the pocket, optical signals transmitted by the optical transmitter are reflected by the documents and thereby prevented from being received by the optical receiver.

5. The apparatus of claim 2, wherein the optical transmitter and the optical receiver are positioned on a common side of the pocket of the document jogger system such that if documents are currently present in the pocket, optical signals transmitted by the optical transmitter are reflected by the documents and received by the optical receiver.

6. The apparatus of claim 1, wherein the document detector includes a proximity sensor that uses proximity sensing to sense whether or not documents are currently located in the pocket.

7. The apparatus of claim 1, wherein the document detector includes a weight sensor that uses weight sensing to sense whether or not documents are currently located in the pocket.

8. The apparatus of claim 1, wherein the document detector includes a sound wave transmitter to transmit sound waves and a sound wave receiver to receive sound waves transmitted by the sound wave transmitter, wherein if documents are currently present in the pocket, sound waves transmitted by the sound wave transmitter are reflected by the documents and thereby prevented from being received by the sound wave receiver.

9. The apparatus of claim 1, further comprising:
visual status indicator circuitry, wherein the controller is also configured to produce a visual status indication signal that indicates at least one condition of the document jogger system, wherein the visual status indicator circuitry is configured to receive the visual status indication signal produced by the controller and to cause at least one visual status indication to be visually displayed by a visual indicator device of the document jogger system.

10. The apparatus of claim 9, wherein said at least one condition includes at least one condition corresponding to a determination by the controller that electrical power is currently being provided to the document jogger system.

11. The apparatus of claim 9, wherein said at least one condition includes at least one condition corresponding to a determination by the controller that a jogging operation is currently being performed by the document jogger system.

12. The apparatus of claim 9, wherein said at least one condition includes at least one condition corresponding to a determination by the controller that a jogging operation has been successfully performed and that documents currently located in a pocket of the document jogger system are ready to be removed from the pocket.

13. A method for use in a document jogger system for activating and deactivating the document jogger system based on determinations as to whether or not documents are currently located in a pocket of the document jogger system, the method comprising:
in a document detector of the document jogger system, detecting whether or not documents are currently located in the pocket of the document jogger system and outputting a document detection signal indicative of whether or not documents are currently located in the pocket;
in a controller of the document jogger system, receiving the document detection signal output by the document detector and performing a document detection algorithm that analyses the document detection signal and determines whether or not documents are currently present in or absent from the pocket, wherein if the controller determines that documents are currently located in the pocket, the controller produces a jogger activation signal; and
in a jogger actuator circuit of the document jogger system, causing a jogger actuator of the document jogger system to be activated if the jogger actuator circuit receives the jogger activation signal produced by the controller, wherein activation of the jogger actuator causes a jogging operation to be performed during which document currently located in the pocket are vibrated.

14. The method of claim 13, wherein the document detector include an optical transmitter and an optical receiver, the optical transmitter being configured to transmit optical signals of a particular wavelength or wavelength range, the optical receiver being configured to detect optical signals of the particular wavelength or wavelength range and to produce the document detection signal that is output from the document detector, wherein if documents are currently located in the pocket, the document detection signal produced by the optical receiver indicates that documents are currently present in the pocket, and wherein if documents are not currently located in the pocket, the document detection signal produced by the optical receiver indicates that documents are currently absent from the pocket.

15. The method of claim 14, wherein the optical transmitter is an infrared (IR) light emitting diode (LED) and wherein the optical receiver is an IR photodiode.

16. The method of claim 14, wherein the optical transmitter and the optical receiver are positioned on opposite sides of the pocket of the document jogger system such that if documents are currently present in the pocket, optical signals transmitted by the optical transmitter are reflected by the documents and thereby prevented from being received by the optical receiver.

17. The method of claim 14 wherein the optical transmitter and the optical receiver are positioned on a common side of the pocket of the document jogger system such that if documents are currently present in the pocket, optical signals transmitted by the optical transmitter are reflected by the documents and received by the optical receiver.

18. The method of claim 13, wherein the document detector includes a proximity sensor that uses proximity sensing to sense whether or not documents are currently located in the pocket.

19. The method of claim 13, wherein the document detector includes a weight sensor that uses weight sensing to sense whether or not documents are currently located in the pocket.

20. The method of claim 13, wherein the document detector includes a sound wave transmitter to transmit sound waves and a sound wave receiver to receive sound waves transmitted by the sound wave transmitter, wherein if documents are currently present in the pocket, sound waves transmitted by the sound wave transmitter are reflected by the documents and thereby prevented from being received by the sound wave receiver.

21. The method of claim 13, further comprising:
in the controller, producing a visual status indication signal that indicates at least one condition of the document jogger system; and
in visual status indicator circuitry of the document jogger system, receiving the visual status indication signal produced by the controller and causing at least one visual status indication to be visually displayed by a visual indicator device of the document jogger system.

22. The method of claim 21, wherein said at least one condition includes at least one condition corresponds to a determination by the controller that electrical power is currently being provided to the document jogger system.

23. The method of claim 21, wherein said at least one condition corresponds to a determination by the controller that a jogging operation is currently being performed by the document jogger system.

24. The method of claim 21, wherein said at least one condition corresponds to a determination by the controller that a jogging operation has been successfully performed and that documents currently located in a pocket of the document jogger system are ready to be removed from the pocket.

25. A computer program comprising computer instructions for execution by one or more processors of a document jogger system for activating and deactivating the document jogger system based on determinations as to whether or not documents are currently located in a pocket of the document jogger system, the program being stored on a computer-readable medium and comprising:
a first set of instructions for receiving a document detection signal indicative of whether or not documents are currently located in a pocket of the document jogger system;
a second set of instructions for analyzing the document detection signal to determine whether or not documents are currently present in or absent from the pocket; and
a third set of instructions for causing a jogger actuator of the document jogger system to be activated if the second set of instructions determines that documents are currently present in the pocket.

26. The computer program of claim 25, further comprising:
a fourth set of instructions for determining whether at least one condition currently exists in the document jogger system; and
a fifth set of instructions for causing at least one visual status indication to be visually displayed by a visual indicator device of the document jogger system if the fourth set of instructions determines that said at least one condition currently exists in the document jogger system.

27. The computer program of claim 26, wherein said at least one condition corresponds to a determination that electrical power is currently being provided to the document jogger system.

28. The computer program of claim 26, wherein said at least one condition corresponds to a determination that a jogging operation is currently being performed by the document jogger system.

29. The computer program of claim 26, wherein said at least one condition corresponds to a determination that a jogging operation has been successfully performed and that documents currently located in a pocket of the document jogger system are ready to be removed from the pocket.
